(19) United States
(12) Patent Application Publication
(10) Pub. No.: US 2014/0311818 A1
(43) Pub. Date: Oct. 23, 2014

(54) GRILLE FOR COVERING A PANEL-MOUNTED SPEAKER

(71) Applicant: Oakwood Energy Management, Inc., Dearborn, MI (US)

(72) Inventors: Richard F. Audi, Dearborn, MI (US); Joel M. Cormier, East Lathrup Village, MI (US); Donald S. Smith, Commerce Township, MI (US)

(21) Appl. No.: 13/865,472

(22) Filed: Apr. 18, 2013

(51) Int. Cl. H04R 1/02

(52) U.S. Cl. CPC H04R 1/023; H04R 2201/02
USPC 181/199

(57) ABSTRACT

A grille 10 for covering an aperture in a panel 16 that supports audio equipment behind a back face of the panel 16, the grille 10 being installed upon a front face of the panel. The grille comprises a formed sheet of pierced and expanded sheet material that has a major axis (A-A) running parallel to a direction in which the sheet is introduced to a forming machine and a minor axis (B-B) that extends orthogonally to the major axis (A-A). The formed sheet has a central portion with surface discontinuities selected that are swirls 18, stiffening furrows 22 and ridges 20 running substantially parallel to the major axis (A-A) and combinations thereof.

### TECHNICAL FIELD

One aspect of the invention relates to audio speaker grilles and covers. Another relates to methods for mounting a speaker grille to an underlying panel or surface such as found in a vehicle or wall in which a speaker opening is formed.

### BACKGROUND

Audio equipment generates sound that is transmitted to a listener from its source through intervening media. Such media include speaker grilles and covers (interchangeably referred to herein as “grilles” or “covers”) that are engineered for protection, ease of installation, visual appearance and sound transmissivity without sacrificing fidelity. Often, added protection is achieved at the expense of sound quality.

Conventional grille covers have been made in plastic. They are detachably mounted on or secured to a substrate panel or frame through tabs or other spring and hook attachment methods. Attachment methods that become weakened in use over time can lead to unfavorable buzzing noises, squeaks or rattles that interfere with acoustic properties.

Some grilles are made from expanded metal. Expanded metal patterns are traditionally created by saw tooth blades. These blades typically have a repeating unit of length referred to as the LWD (long way diamond) whose angles and flat dimensions are defined to create a pattern with desired characteristics. These blades expand the metal by taking an indexed amount of material called the strand width (SW) and subsequently shearing and stretching material over a lower striker bar until it conforms to the shape of the blade. When the blade is square to the striker bar and SW is constant, a uniform pattern is created which most would identify as standard expanded metal whose appearance is uniform over the entire surface.

Before filing this application, the following U.S. Patents were considered: Nos. 5,652,413; 5,565,659; and 4,974,698.

### SUMMARY OF INVENTION

One aspect of the disclosure comprehends a grille for covering an aperture in a panel that supports audio equipment attached to a back face of the panel, the grille being installed upon a front face of the panel. The grille comprises a formed sheet of pierced and expanded sheet material that has a major axis (A-A) running parallel to a direction in which the sheet is introduced to a forming machine and a minor axis (B-B) that extends orthogonally to the major axis (A-A). The formed sheet has a central generally planar or domed portion with surface discontinuities selected from the group consisting of swirls, stiffening furrows and ridges running substantially parallel to the major axis (A-A) and combinations thereof

### BRIEF DESCRIPTION OF THE DRAWINGS

FIG. 1 is a top plan view of an embodiment of a speaker grille cover;

FIG. 2 is a cross sectional view thereof;

FIG. 3 is an illustrative procedural flow diagram; and

FIGS. 4-7 illustrate various arrangements of skips or ribs or furrows that extend to tabs associated with the cover.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

### Structure

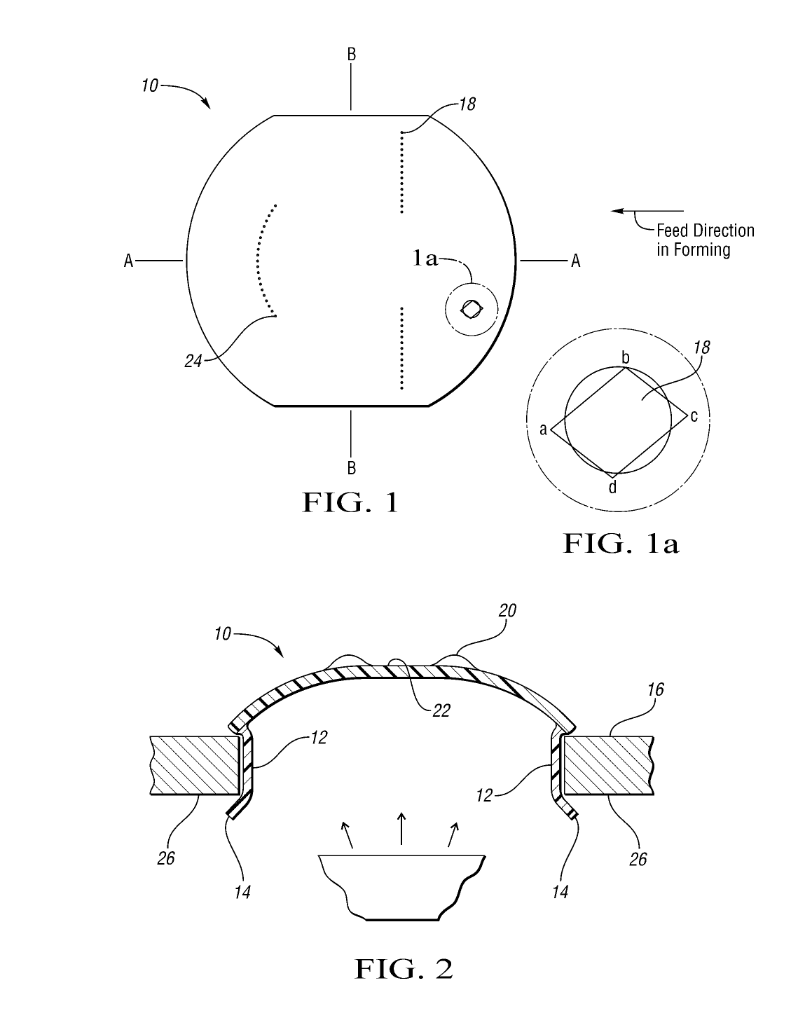

As exemplified in FIGS. 1-2, the speaker grilles 10 of this disclosure when viewed from above are round, oval or generally rectangular. They may be planar or domed. Arrayed around a periphery of a grille 10 is a downturned edge 12 from which attachment tabs 14 extend for detachably attaching the grille 10 to an underlying panel 16 or other support surface. It will be appreciated that “underlying” as used herein should not be construed as “above” in the sense of top and bottom. In some applications the grille may be mounted to a vertical or inclined supporting wall surface.

One aspect of several embodiments of the disclosed product is that the grilles are relatively stiff in one direction (e.g., A-A), yet compliant in another (“anisotropic”) (e.g., B-B). Most embodiments are longer in one direction than in another direction. As a frame of reference, a major axis (A-A) (FIG. 1) can be considered as characterizing the longer of the two dimensions. A minor axis (B-B) that lies orthogonally to the major axis can be considered as characterizing the smaller of the two dimensions.

Skips 18 are created in a forming step perpendicularly to the direction in which feed stock is introduced to a forming machine. In general the skips 18 are oriented parallel to the minor axis. One row is shown in FIG. 1.

If present, the ridge lines 20 (FIG. 2) are characterized by laterally extending ridges with valleys 22 interposed there between. Such structures generally offer stiff resistance to bending forces that are exerted parallel to the minor axis. In contrast, the speaker grille covers that are bent by forces exerted parallel to the major axis are relatively compliant. These characteristics facilitate the task of attaching opposing edges 14 of the speaker grille cover 10 to a support panel. For example, in attaching the grille 10 to the panel, the grille 10 is first bent so that attachment tabs extending from the downwardly extending edge adjacent to the minor axis are first presented to the panel. Then the tabs adjacent to an opposing edge are presented to the panel and the grille 10 is secured there to.

Depending on the parameters of machining, localized surface discontinuities in speaker grilles can be created by material discontinuities that are referred to herein as “skips” 18. Such features are created by momentarily interrupting the feed rate of stock as it passes through or under a perforation tool that penetrates at a relatively constant rate or by altering the periodicity with which the tool perforates stock that is introduced to the tool at a relatively uniform feed rate.

Such skips 18 typically lie along a linear path and extend over the entire width of the feed stock as shown in FIG. 1, but can be created over less than the entire width if desired.

The skips 18 alter the visual appearance of the grille, which takes on different hues or appearances depending on the vantage point of the observer and the light that is incident on the grille 10. They thus enhance the appearance of the grille without reducing its ability to allow sound to pass there through with minimal distortion.

In some embodiments, the skips lie in an arcuate path 24. This effect is produced by altering the feed rate across the width of the feed stock. For example, a feed rate along one edge of the stock may be (X) cm/sec, but the feed rate along the opposite edge may be (X±ΔX) cm/sec. This creates a visually attractive swirl appearance, in which adjacent cells 18 in the expanded material trace an arcuate or curvilinear path. This effect can be prepared not only by changing the feed rate across the width of incoming feed stock in order to create different patterns, but also by altering the impact timing of multiple teeth along a row of teeth in a tool as they penetrate feed stock that passes at a uniform throughput rate.

Alternatively, unit cell size of a skip can be varied from one edge to another edge across a given roll or width of feed stock. This is enabled by providing punching tools with teeth or punches of different dimensions across the width of the metal stock. Thus, it is possible to prepare a sheet of expanded metal having edges in which the hole spacing adjacent to one edge is more densely packed than hole spacing at the opposite edge.

For analysis, a given skip can be considered as a unit cell having for example four edges that are defined by strands of material which are connected at their ends to form in one example a quadrilateral cell with edges a-b, b-c, c-d and d-a. It will be appreciated that the invention is not so limited. Some cells may have two edges (slits or slots), three edges or more than four edges. Further, the unit cell 18 may not emerge from the tool as planar. For instance the edge a-b may have a different inclination to a reference plane than one or more of the other edges. Similarly for the sizes of edges in a given cell.

In addition to skips, ribs 20 can optionally be prepared that extend generally parallel to a major axis (A-A) of the speaker grille cover. If present, the ribs can be separated by furrows or valleys 22. The ribs strengthen the grille cover's resistance to bending forces applied along their length. In this sense, the grille becomes anisotropic. Not only do such features influence the structural characteristics of the formed grille but also they influence its visual characteristics without significant detrimental effect on acoustic properties.

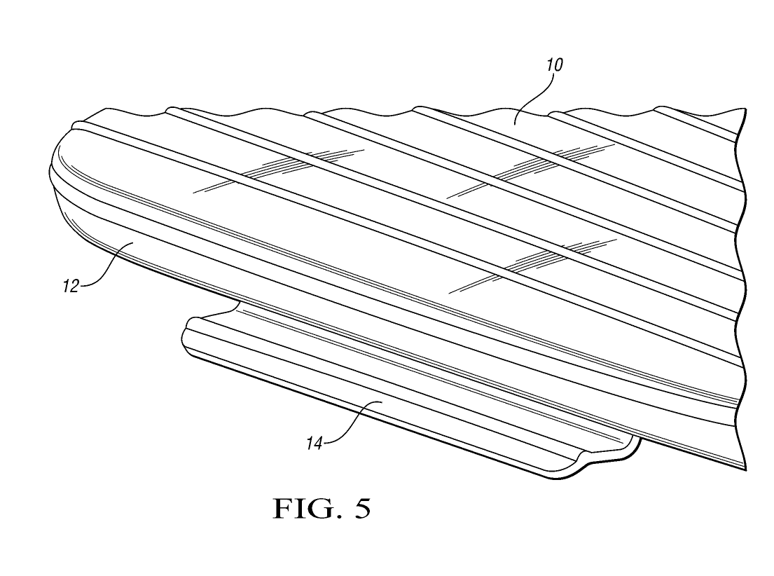

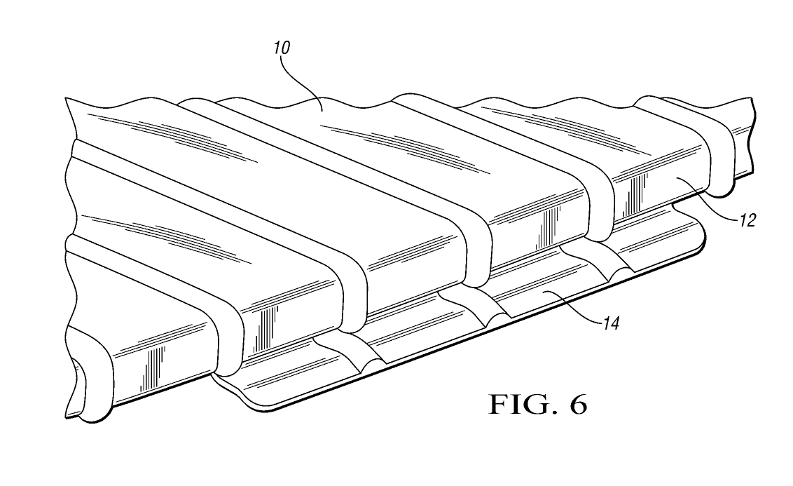

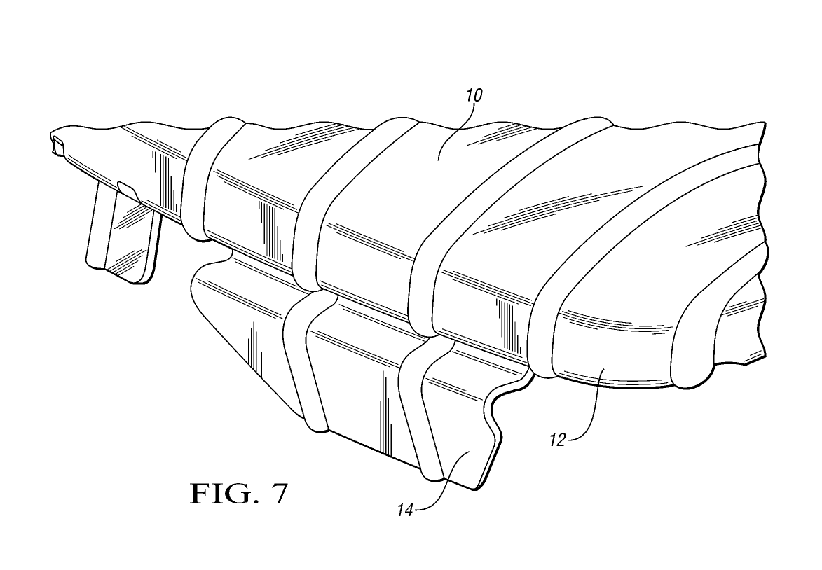

Skips and/or ribs or skips alone may also extend to the underlying attachment tabs 14 (FIGS. 4-7) that are deployed around the edges 12 of the grille 10. Depending on the orientation of the tab 14 in relation to the skip 18 or rib 20 or furrow 22, the tab 14 may be made stiffer or more compliant in securing the grille 10 to the supporting panel or substrate 16.

### Method of Manufacture

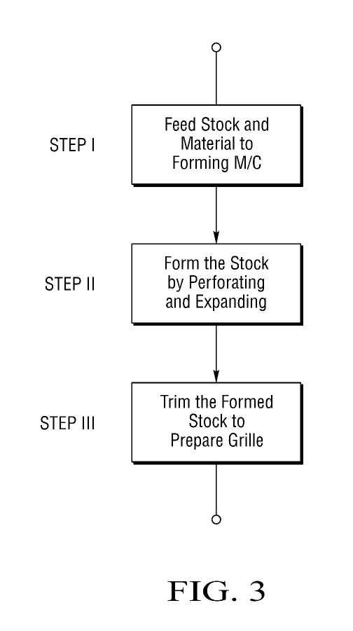

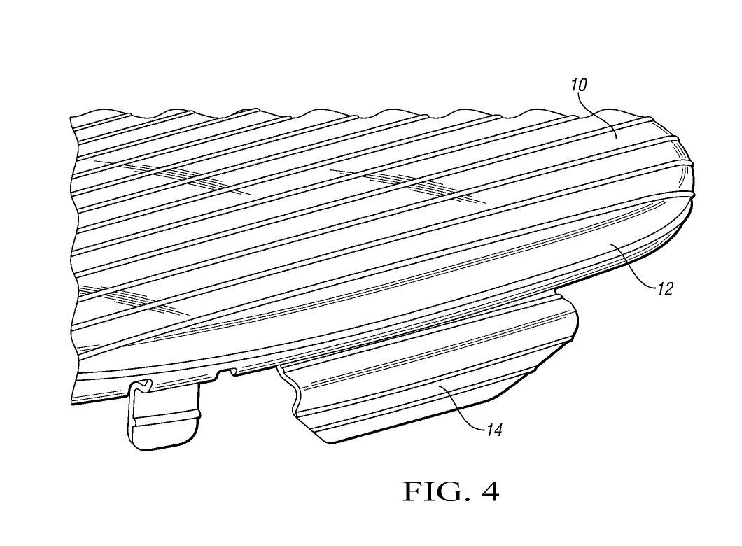

In one embodiment, the speaker grille 10 of the present invention is manufactured from a sheet of mild steel or plastic. The sheet is passed through a forming tool (FIG. 3, Step I) that creates expanded material such as expanded metal. Expanded metal is metal stock that is sheared and perforated (Step II) in a press. The metal stretches and leaves diamond-shaped voids that are surrounded by interlinked bars of the metal. See, e.g., http://en.wikipedia.org/wiki/Expanded_metal. The formed material is then trimmed to size (Step III). One method of manufacture calls for simultaneously slitting and stretching the sheet material with one motion. As noted earlier, optionally the starting material may be a plastic.

As mentioned earlier, expanded metal patterns are traditionally created by saw tooth blades. These blades typically have a repeating unit of length referred to as the LWD (long way diamond) whose angles and flat dimensions are defined to create a pattern with desired characteristics. These blades expand the metal by taking an indexed amount of material called the strand width (SW) and subsequently shearing and stretching material over a lower striker bar until it conforms to the shape of the blade. When the blade is square to the striker bar and SW is constant, a uniform pattern is created which most would identify as standard expanded metal whose appearance is uniform over the entire surface.

One aspect of this disclosure incorporates a fade pattern. It was found that a variety of looks could be created maintaining the blade square to the striker bar but varying the SW in a pattern that may or may not repeat. A nearly infinite sequence of SW changes can be programmed into the feed system which changes the amount of material that is metered out per unit expansion. This results in areas of variable density in the feed (SW) direction. These areas of variable density create an appearance that is different from traditional expanded metal.

Another aspect of this disclosure includes a fan pattern. A fan pattern is created by setting the blade at an angle relative to the striker bar. For a constant strand width pattern, one side of the material will expand at a faster rate relative to the other. The expanded material appears to “fan” out from the expansion tool.

Combinations of the above are also anticipated.

### Attributes

One attribute of the speaker grille covers that are manufactured following the disclosed practices is that they have a visual appeal without sacrificing acoustic properties. When exposed to light they have alternating translucency and opacity depending on their orientation to illumination or the vantage point of the observer. Several embodiments create a unique appearance by changing the plane of formation and/or density of apertures or cells per unit dimension (e.g. per square inch).

Thus an otherwise bland structural grille can be transformed into a visually appealing yet functional object that allows sound to pass there through without sacrificing acoustic quality.

### Method of Attachment to an Underlying Panel

In one embodiment, there are two stages of attachment: 1) deflection of an attachment feature, such as a holding tab 14; and 2) after the deflected tab 14 is lowered into an aperture defined in the supporting panel 16, snapping the tab into place on an undersurface 26 of the panel. The attachment features include optional locking mechanisms and optional gripping mechanisms.

During the manufacturing step it is thought that some work hardening occurs at ambient temperatures in the edge 12 and tabs 14 that extend therefrom that are respectively turned downwardly and deflected backwardly from the plane of the grille. Additionally (FIGS. 4-7) the presence of skips 18 or ribs 20 influence the retention or holding forces that are exerted by holding tabs 14 in relation to the panel or substrate 16 to which the grille 10 is attached. For example if desired, retention forces exerted by a given pair of opposing edges can be tuned to be stronger or weaker than those exerted by the other pair of opposite edges in a four-sided grille, depending on their orientation in relation to a set of ridges or furrows 20.

By practicing the techniques disclosed herein, it is possible to create speaker grille covers 10 that not only offer an enhanced visual appearance, but have audio characteristics that are substantially unchanged by the visual enhancements enabled by skips or swirls caused by changes in the spacing between or relative orientation of adjacent cells in the expanded metal. The inventors have found that high-frequency sound and bass tones are transmitted with good fidelity.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A grille for covering an aperture in a panel that supports audio equipment behind a back face of the panel, the grille being installed upon a front face of the panel, the grille comprising:
a formed sheet of pierced and expanded sheet material that has
a major axis (A-A) running parallel to a direction in which the sheet is introduced to a forming machine and
a minor axis (B-B) that extends orthogonally to the major axis (A-A),
a central portion with surface discontinuities selected from the group consisting of swirls, stiffening furrows and ridges running substantially parallel to the major axis (A-A) and combinations thereof.

2. The grille of claim 1, the grille having a perimeter that is round, oval, elliptical or generally rectangular or has a pair of parallel edges that are joined by curvelinear edges.

3. The grille of claim 1, the grille having a central portion that is planar or domed.

4. The grille of claim 1, the grille having a periphery with a downturned edge.

5. The grille of claim 4, wherein attachment tabs extend from the downturned edge for detachably attaching the grille to an underlying panel or other support surface.

6. The grille of claim 5, wherein the panel is horizontally oriented, vertically oriented or is inclined.

7. The grille of claim 1, wherein the grille is relatively stiff in its response to bending forces about one axis of rotation, yet compliant in response to forces exerted about another axis of rotation.

8. The grille of claim 1, wherein the periphery is longer in one direction than in another direction such that a major axis (A-A) can be considered to characterize the longer of the two dimensions and a minor axis (B-B) lies orthogonally to the major axis, the minor axis characterizing the smaller of the two dimensions, and wherein there is a number (N) of ridges where O<N<100.

9. The grille of claim 1, wherein there is a number (M) of skips wherein O<M<10,000 and the skips are created in a forming step perpendicularly to the direction in which feed stock is introduced to a forming machine so that the skips are oriented parallel to the minor axis.

10. The grille of claim 1, wherein the ridge lines are lie between valleys interposed there between so that such grilles generally offer stiff resistance to bending forces that are exerted parallel to the minor axis and when the grille is subjected to forces exerted parallel to the major axis, the grille is relatively compliant.

11. The grille of claim 1, wherein the skips the are created by momentarily interrupting the feed rate of stock as it passes through or under a perforation tool that penetrates at a relatively constant rate or by altering the periodicity with which the tool perforates stock that is introduced to the tool at a relatively uniform feed rate.

12. The grille of claim 1, wherein the skips lie along a linear path and extend over the entire width of the feed stock.

13. The grille of claim 1, wherein the skips lie along a linear or arcuate path and extend over less than the entire width of the feed stock.

14. The grille of claim 1, wherein the skips alter the visual appearance of the grille, which takes on different hues or appearances depending on the vantage point of the observer and the light that is incident on the grille, thereby enhancing the appearance of the grille without significantly reducing its ability to allow sound to pass there through with minimal distortion.

15. The grille of claim 1, wherein the skips lie in an arcuate path.

16. The grille of claim 15, wherein the arcuate path is produced by altering the feed rate across the width of the feed stock so that if a feed rate along one edge of the stock is (X) cm/sec, the feed rate along the opposite edge is (X±ΔX) cm/sec.

17. The grille of claim 15, wherein the arcuate path is produced by altering the impact timing of multiple teeth along a row of teeth in a tool as they influence feed stock that passes at a uniform throughput rate.

18. The grille of claim 1, wherein the unit cell size of a skip is varied from one edge to another edge of feedstock across a given roll or width.

19. The grill of claim 1 wherein a skip has four edges that are defined by strands of material that are connected at their ends to form a quadrilateral with edges: a-b, b-c, c-d and d-a.

20. The grill of claim 19 wherein the skip emerges from a forming tool in a non-planar form.

21. The grille of claim 5, wherein the skips extend from the planar portion of the grille to the attachment tabs so that depending on the orientation of a tab in relation to a skip or rib or furrow, the tab may be stiffer or more compliant in securing the grille to the supporting panel.
